(19) United States
(12) Patent Application Publication
(10) Pub. No.: US 2026/0064279 A1
(43) Pub. Date: Mar. 5, 2026

(54) MEMORY SYSTEM AND OPERATING METHOD OF MEMORY SYSTEM

(71) Applicant: SK hynix Inc., Gyeonggi-do (KR)

(72) Inventor: Du Hyun KIM, Gyeonggi-do (KR)

(21) Appl. No.: 18/991,705

(22) Filed: Dec. 23, 2024

(30) Foreign Application Priority Data
Sep. 2, 2024 (KR) 10-2024-0118555

(51) Int. Cl. G06F 3/06

(52) U.S. Cl. CPC G06F 3/0613; G06F 3/0656; G06F 3/0659

(57) ABSTRACT

A memory system includes a memory sub-system, and a controller configured to transmit, to the memory sub-system, a read command corresponding to a speculative read request according to a quantity of remaining credits, receive, from the memory sub-system, read data corresponding to the speculative read request, and adjust a total quantity of credits and the quantity of remaining credits according to whether the read data is a speculative read hit.

### CROSS-REFERENCES TO RELATED APPLICATION

The present application claims priority under 35 U.S.C. § 119(a) to Korean patent application number 10-2024-0118555 filed on Sep. 2, 2024, which is incorporated herein by reference in its entirety.

### BACKGROUND

### 1. Technical Field

Embodiments of the present disclosure relate to a memory system.

### 2. Related Art

In a computing system, the way a host device accesses a memory device may have a significant impact on system performance. Specifically, read latency that occurs when the host device reads data from the memory device may be a major cause of degraded system performance. To reduce the read latency, a memory system may use a buffer that is capable of being accessed faster than the memory device. In addition, a speculative read technique may effectively reduce the read latency by predicting data to be required by the host device in the future and reading the data into the buffer. By utilizing the buffer and the speculative read technique, the memory system may provide the host device with the necessary data faster and reduce a memory access bottleneck phenomenon, thereby improving the overall performance of the memory system.

### SUMMARY

A memory system according to an embodiment of the present disclosure may include a memory sub-system; and a controller configured to transmit, to the memory sub-system, a read command corresponding to a speculative read request according to a quantity of remaining credits, receive, from the memory sub-system, read data corresponding to the speculative read request, and adjust a total quantity of credits and the quantity of remaining credits according to whether the read data is a speculative read hit.

A memory system according to an embodiment of the present disclosure may include a memory sub-system; and a controller configured to transmit a read command to the memory sub-system in response to a speculative read request received from a host device or discard the speculative read request without transmitting the read command to the memory sub-system, according to a quantity of remaining credits.

An operating method of a memory system according to an embodiment of the present disclosure may include receiving a speculative read request from a host device; transmitting, to a memory sub-system, a read command corresponding to the speculative read request according to a quantity of remaining credits and decreasing the quantity of remaining credits based on the transmission of the read command; increasing the quantity of remaining credits based on receiving read data corresponding to the speculative read request from the memory sub-system; and adjusting a total quantity of credits and the quantity of remaining credits according to whether the read data is a speculative read hit.

### BRIEF DESCRIPTION OF THE DRAWINGS

FIG. 1 is a block diagram illustrating a memory system, according to an embodiment of the present disclosure.

FIG. 2 is a diagram illustrating a change in a quantity of credits, according to an embodiment of the present disclosure.

FIGS. 3 to 8 are block diagrams illustrating an operation of a controller, according to an embodiment of the present disclosure.

FIG. 9 is a flowchart illustrating an operation of a memory system, according to an embodiment of the present disclosure.

### DETAILED DESCRIPTION

Hereinafter, embodiments of the present disclosure will be described in more detail with reference to the accompanying drawings.

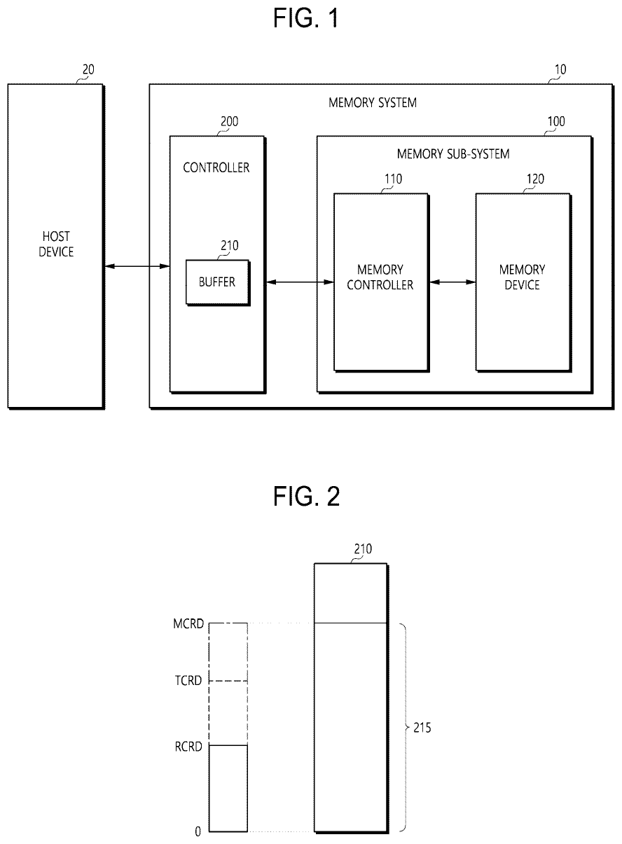

FIG. 1 is a block diagram illustrating a memory system 10, according to an embodiment of the present disclosure.

The memory system 10 may store data under the control of a host device 20. The memory system 10 may include a personal computer memory card international association (PCMCIA) card, a smart media card, a memory stick, various multi-media cards (e.g., MMC, eMMC, RS-MMC, and MMC-micro), a secure digital (SD) card (e.g., SD, Mini-SD, and Micro-SD), a universal flash storage (UFS), or a solid state drive (SSD).

According to an embodiment, the memory system 10 may communicate with the host device 20 based on a compute express link (CXL) interface. The CXL interface may improve a communication speed between the host device 20, for example, a central processing unit, and the memory system 10 in a high-performance computing system. The CXL interface may effectively reduce read latency by supporting a speculative read request, which is to be described below.

The memory system 10 may include a memory sub-system 100 and a controller 200. The memory sub-system 100 may include a memory controller 110 and a memory device 120. The controller 200 may include a buffer 210.

The memory controller 110 may access the memory device 120 in response to a command received from the controller 200. For example, the memory controller 110 may store data in the memory device 120 in response to a write command received from the controller 200. The memory controller 110 may read data from the memory device 120 in response to a read command received from the controller 200 and transmit the data to the controller 200.

The memory device 120 may store data under the control of the memory controller 110. The memory device 120 may include a non-volatile memory device and/or a volatile memory device. The non-volatile memory device may include a NAND flash Memory, a 3D NAND flash memory, a NOR flash memory, a resistive random access memory (RRAM), a phase-change memory (PRAM), a magneto-resistive random access memory (MRAM), a ferroelectric random access memory (FRAM), and a spin transfer torque random access memory (STT-RAM). The volatile memory device may include a dynamic random access memory (DRAM) and a static random access memory (SRAM).

The controller 200 may transmit a command to the memory sub-system 100 in response to a request from the host device 20. For example, the controller 200 may transmit the write command to the memory sub-system 100 in response to a write request from the host device 20. In addition, the controller 200 may transmit the read command to the memory sub-system 100 in response to a read request from the host device 20.

The read request from the host device 20 may include a speculative read request and a normal read request. The speculative read request may be a request of reading in advance data, which is predicted to be needed in the future, from the memory sub-system 100 to the buffer 210. The normal read request may be a request of transmitting, to the host device 20, data required by the host device 20. When the normal read request for specific read data is received until a predetermined valid time from the time when the speculative read request for the specific read data is received, the controller 200 may quickly transmit, to the host device 20, the read data, which has been read in advance to the buffer 210 by the speculative read request. Therefore, the read latency for the normal read request may be effectively reduced.

The controller 200 may transmit, to the memory sub-system 100, the read command corresponding to the speculative read request based on a quantity of remaining credits. The controller 200 may transmit, to the memory sub-system 100, the read command corresponding to the speculative read request based on a determination that the quantity of remaining credits is greater than a reference value (e.g., zero (0)), and decrease the quantity of remaining credits based on the transmission of the read command. The controller 200 may discard the speculative read request without transmitting the read command to the memory sub-system 100, based on the determination that the quantity of remaining credits is 0.

When the memory sub-system 100 transmits, to the controller 200, the read data, which corresponds to the speculative read request, in response to the read command corresponding to the speculative read request, the controller 200 may increase the quantity of remaining credits based on the receiving of the read data corresponding to the speculative read request.

The controller 200 may store, in the buffer 210, the read data corresponding to the speculative read request and not transmit the read data to the host device 20. The controller 200 may not transmit, to the host device 20, a response corresponding to the speculative read request.

The controller 200 may adjust a total quantity of credits and the quantity of remaining credits depending on whether the read data corresponding to the speculative read request is a speculative read hit. Specifically, the controller 200 may determine that the read data is the speculative read hit, based on receiving the normal read request corresponding to the speculative read request from the host device 20 until a predetermined valid time from the time the speculative read request is received. The normal read request corresponding to the speculative read request may be a request of transmitting, to the host device 20, the read data corresponding to the speculative read request. The controller 200 may increase the total quantity of credits and the quantity of remaining credits based on the determination that the read data is the speculative read hit. The controller 200 may determine that the read data is a speculative read miss, based on not receiving the normal read request corresponding to the speculative read request from the host device 20 until the predetermined valid time from the time when the speculative read request is received. The controller 200 may decrease the total quantity of credits based on the determination that the read data is the speculative read miss.

When the read data corresponding to the speculative read request is the speculative read hit, that is, the controller 200 receives the normal read request corresponding to the speculative read request, the controller 200 may transmit, to the host device 20, the corresponding read data from the buffer 210 in response to the normal read request.

Even when read data corresponding to a normal read request unrelated to the speculative read request is already stored in the buffer 210, the controller 200 may transmit, to the host device 20, the read data from the buffer 210 in response to the normal read request. When the read data corresponding to the normal read request is not stored in the buffer 210, for example, when the normal read request is unrelated to the speculative read request, when the corresponding speculative read request is discarded, etc., the controller 200 may transmit, to the memory sub-system 100, a read command corresponding to the normal read request, receive the read data corresponding to the normal read request from the memory sub-system 100 and transmit the read data to the host device 20.

According to an embodiment, the controller 200 may transmit a speculative read command to the memory sub-system 100 in response to the speculative read request and transmit, to the memory sub-system 100, a normal read command, which is distinct from the speculative read command, in response to the normal read request. The memory sub-system 100 may distinguish between the speculative read command and the normal read command and process the speculative read command and the normal read command according to a predetermined priority.

FIG. 2 is a diagram illustrating a change in a quantity of credits, according to an embodiment of the present disclosure.

Referring to FIG. 2, a total quantity of credits TCRD may represent the total quantity of credits currently held by the memory system 10. The total quantity of credits TCRD may also represent a maximum quantity of speculative read requests that the memory system 10 is capable of processing simultaneously.

A quantity of remaining credits RCRD may represent a quantity of remaining credits that the memory system 10 is currently capable of using. Whenever the memory system 10 read-accesses the memory sub-system 100 or transmits a read command corresponding to a speculative read request to the memory sub-system 100 in response to the speculative read request, one credit may be used, that is, the quantity of remaining credits RCRD may decrease. Whenever the speculative read request is completely processed or read data corresponding to the speculative read request is received from the memory sub-system 100, one credit may be recovered, that is, the quantity of remaining credits RCRD may increase. When the memory system 10 is booted, the quantity of remaining credits RCRD may be equal to the total quantity of credits TCRD. When read commands corresponding to speculative read requests for as many as the total quantity of credits TCRD are transmitted to the memory sub-system 100 and no read data corresponding to the speculative read requests has been read yet, the quantity of remaining credits RCRD may be 0.

A maximum quantity of credits MCRD may represent a maximum limit of credits that the memory system 10 is capable of holding. The total quantity of credits TCRD may increase to the maximum quantity of credits MCRD based on a determination that read data is a speculative read hit or decrease to 1 based on a determination that read data is a speculative read miss. The maximum quantity of credits MCRD may correspond to a maximum size of an area 215 allocable for processing the speculative read requests in the buffer 210. The size of the area 215 allocable for processing the speculative read requests in the buffer 210 may vary.

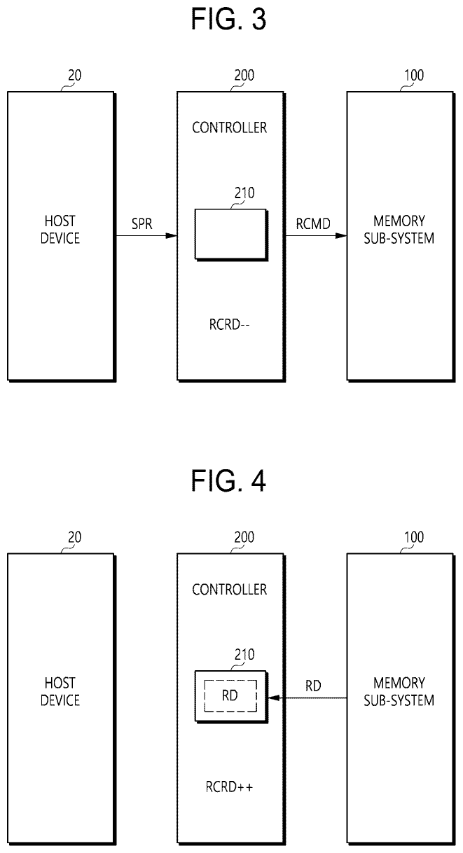

FIGS. 3 to 8 are block diagrams illustrating an operation of the controller 200, according to an embodiment of the present disclosure.

Referring to FIG. 3, the host device 20 may transmit a speculative read request SPR to the controller 200. When the quantity of remaining credits RCRD is greater than a reference value (e.g., zero (0)), the controller 200 may transmit a read command RCMD to the memory sub-system 100 in response to the speculative read request SPR. In addition, the controller 200 may decrease (i.e., RCRD−−) the quantity of remaining credits RCRD by one (1) based on the transmission of the read command RCMD.

Referring to FIG. 4, the memory sub-system 100 may transmit, to the controller 200, read data RD corresponding to the read command RCMD in response to the read command RCMD illustrated in FIG. 3. The controller 200 may store, in the buffer 210, the read data RD received from the memory sub-system 100. When the read data RD corresponds to the speculative read request SPR illustrated in FIG. 3, and the quantity of remaining credits RCRD is less than the total quantity of credits TCRD, the controller 200 may increase (i.e., RCRD++) the quantity of remaining credits RCRD by 1 based on the receiving of the read data RD. When the quantity of remaining credits RCRD is equal to the total quantity of credits TCRD, the controller 200 may not increase the quantity of remaining credits RCRD even though the read data RD corresponds to the speculative read request SPR.

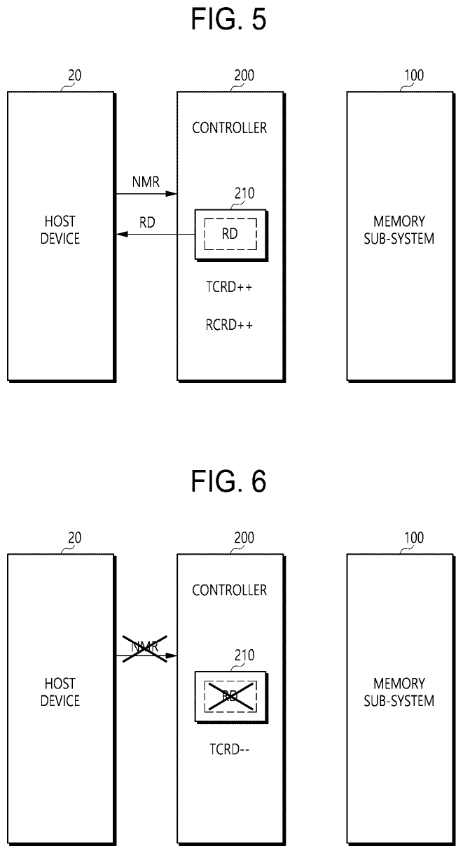

Referring to FIG. 5, the controller 200 may determine whether the read data RD corresponding to the speculative read request SPR is a speculative read hit or a speculative read miss. When the controller 200 receives, from the host device 20, a normal read request NMR corresponding to the speculative read request SPR until a predetermined valid time from the time the controller 200 receives, from the host device 20, the speculative read request SPR illustrated in FIG. 3, the controller 200 may determine that the read data RD is the speculative read hit. In one example, the predetermined valid time may be the time when the read data RD corresponding to the speculative read request SPR is completely stored in the buffer 210. In another example, the predetermined valid time may be the time when a predetermined time elapses from the time when the read data RD corresponding to the speculative read request SPR is completely stored in the buffer 210. In still another example, the predetermined valid time may be the time when a predetermined time elapses from the time when the speculative read request SPR is received from the host device 20.

When it is determined that the read data RD is the speculative read hit, the read data RD corresponding to the speculative read request SPR may be transmitted from the buffer 210 to the host device 20. The controller 200 may increase (i.e., TCRD++) the total quantity of credits TCRD by a predetermined quantity, for example, 1 and increase (i.e., RCRD++) the quantity of remaining credits RCRD by 1, based on the determination that the read data RD is the speculative read hit.

Referring to FIG. 6, when the controller 200 does not receive, from the host device 20, the normal read request NMR corresponding to the speculative read request SPR until the predetermined valid time from the time the controller 200 receives the speculative read request SPR illustrated in FIG. 3, the controller 200 may determine that the read data RD corresponding to the speculative read request SPR is the speculative read miss. The controller 200 may decrease (i.e., TCRD−−) the total quantity of credits TCRD by a predetermined quantity, for example, 1 based on the determination that the read data RD is the speculative read miss. The controller 200 may remove, from the buffer 210, the read data RD, which is determined as the speculative read miss. Although the controller 200 decreases the total quantity of credits TCRD by the predetermined quantity based on the determination that the read data RD is the speculative read miss, the quantity of remaining credits RCRD may not change.

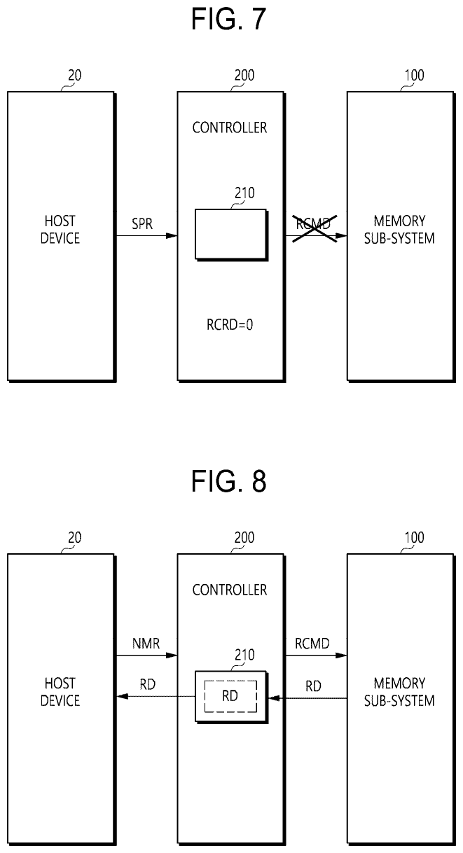

Referring to FIG. 7, the host device 20 may transmit the speculative read request SPR to the controller 200. When the quantity of remaining credits RCRD is 0, the controller 200 may discard the speculative read request SPR without transmitting, to the memory sub-system 100, the read command RCMD corresponding to the speculative read request SPR. The quantity of remaining credits RCRD being 0 may represent that the memory sub-system 100 has not yet processed read commands corresponding to speculative read requests for as many as the total quantity of credits TCRD. Therefore, as the controller 200 discards the speculative read request SPR, execution of other operations may be prevented from being delayed due to excessive memory throughput.

To sum up, the larger the total quantity of credits TCRD, the lower a possibility that the speculative read request SPR is discarded, and the smaller the total quantity of credits TCRD, the higher the possibility that the speculative read request SPR is discarded. In addition, a large quantity of speculative read misses may represent that there are many unnecessary read operations for the memory device 120. Therefore, as the total quantity of credits TCRD is adjusted according to speculative read hits and speculative read misses, a situation in which the unnecessary read operations occupy the memory throughput may be improved. Consequently, the performance of the memory system 10 may be improved.

When the normal read request NMR corresponding to the speculative read request SPR is received after the speculative read request SPR is discarded, the controller 200 may process the normal read request NMR as described with reference to FIG. 8, regardless of the speculative read request SPR.

Referring to FIG. 8, the host device 20 may transmit the normal read request NMR to the controller 200. The controller 200 may determine whether to transmit the read command RCMD corresponding to the normal read request NMR to the memory sub-system 100. Specifically, the controller 200 may transmit, to the memory sub-system 100, the read command RCMD corresponding to the normal read request NMR when the read data RD corresponding to the normal read request NMR is not present in the buffer 210.

For example, when the speculative read request SPR corresponding to the normal read request NMR is discarded as described with reference to FIG. 7, the read data RD corresponding to the normal read request NMR may not be present in the buffer 210. In another example, when the normal read request NMR is transmitted from the host device 20 without a preceding speculative read request, the read data RD corresponding to the normal read request NMR may not be present in the buffer 210. In another example, when the normal read request NMR is transmitted from the host device 20 after a predetermined valid time after the speculative read request corresponding to the normal read request NMR is transmitted, the read data RD corresponding to the normal read request NMR may be deleted from the buffer 210.

The memory sub-system 100 may transmit, to the controller 200, the read data RD corresponding to the normal read request NMR in response to the read command RCMD corresponding to the normal read request NMR. The controller 200 may store the read data RD in the buffer 210 and then transmit the read data RD from the buffer 210 to the host device 20.

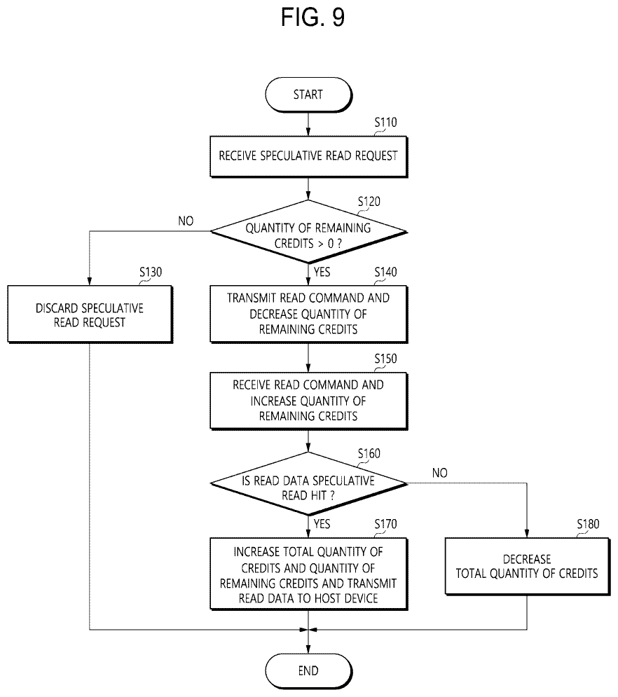

FIG. 9 is a flowchart illustrating an operation of the memory system 10, according to an embodiment of the present disclosure.

Referring to FIG. 9, in S110, the controller 200 may receive a speculative read request from the host device 20.

In S120, the controller 200 may determine whether a quantity of remaining credits is greater than a reference value (e.g., 0). Based on the determination that the quantity of remaining credits is 0, the process may proceed to S130. Based on the determination that the quantity of remaining credits is greater than 0, the process may proceed to S140.

In S130, the controller 200 may discard the speculative read request without transmitting, to the memory sub-system 100, a read command corresponding to the speculative read request. The process may terminate.

In S140, the controller 200 may transmit, to the memory sub-system 100, the read command corresponding to the speculative read request and decrease the quantity of remaining credits by a reference value (e.g., 1) based on the transmission of the read command.

In S150, the controller 200 may receive, from the memory sub-system 100, read data corresponding to the speculative read request and store the read data in the buffer 210. The controller 200 may increase the quantity of remaining credits by a reference value (e.g., 1) based on the receiving of the read data corresponding to the speculative read request.

In S160, the controller 200 may determine whether the read data corresponding to the speculative read request is a speculative read hit or a speculative read miss. When the controller 200 receives a normal read request corresponding to the speculative read request until a predetermined valid time from the time when the speculative read request is received, the controller 200 may determine that the read data corresponding to the speculative read request is the speculative read hit. When the controller 200 does not receive the normal read request corresponding to the speculative read request until the predetermined valid time from the time when the speculative read request is received, the controller 200 may determine that the read data corresponding to the speculative read request is the speculative read miss. Based on the determination that the read data corresponding to the speculative read request is the speculative read hit, the process may proceed to S170. Based on the determination that the read data corresponding to the speculative read request is the speculative read miss, the process may proceed to S180.

In S170, the controller 200 may increase a total quantity of credits and the quantity of remaining credits by a reference value (e.g., 1). In response to the normal read request, the controller 200 may transmit, to the host device 20, read data corresponding to the normal read request from the buffer 210.

In S180, the controller 200 may decrease the total quantity of credits by a reference value (e.g., 1). The controller 200 may remove the read data, which is determined as the speculative read miss, from the buffer 210.

Although embodiments of the present disclosure have been described for illustrative purposes, those skilled in the art will appreciate that various modifications and changes are possible, without departing from the essential features of the embodiment. Accordingly, the embodiments disclosed in the present disclosure are not intended to limit but illustrate the technical scope of the present disclosure. The protection scope of the embodiments of the present disclosure should be construed based on the following appended claims. Moreover, it should be interpreted that all technical details included within the present disclosure which are identical or equivalent to the claims are included within the scope of the present disclosure. Furthermore, the embodiments may be combined to form additional embodiments.

What is claimed is:

1. A memory system comprising:
a memory sub-system; and
a controller configured to:
transmit, to the memory sub-system, a read command corresponding to a speculative read request according to a quantity of remaining credits,
receive, from the memory sub-system, read data corresponding to the speculative read request, and
adjust a total quantity of credits and the quantity of remaining credits according to whether the read data is a speculative read hit.

2. The memory system according to claim 1, wherein the controller transmits the read command to the memory sub-system based on a determination that the quantity of remaining credits is greater than a reference value and decreases the quantity of remaining credits based on the transmission of the read command.

3. The memory system according to claim 1, wherein the controller discards the speculative read request without transmitting the read command to the memory sub-system, based on determination that the quantity of remaining credits is a reference value.

4. The memory system according to claim 1, wherein the controller increases the quantity of remaining credits based on receiving the read data from the memory sub-system.

5. The memory system according to claim 1, wherein the controller includes a buffer configured to store the read data, and
wherein the total quantity of credits is less than or equal to a maximum quantity of credits, which corresponds to a maximum size of an area allocable for processing speculative read requests in the buffer.

6. The memory system according to claim 1, wherein the controller determines that the read data is the speculative read hit, based on receiving a normal read request corresponding to the speculative read request until a predetermined valid time from a time when the speculative read request is received.

7. The memory system according to claim 6, wherein the controller transmits the read data to the host device as a response corresponding to the normal read request, instead of a response corresponding to the speculative read request.

8. The memory system according to claim 1, wherein the controller increases the total quantity of credits and the quantity of remaining credits based on determination that the read data is the speculative read hit.

9. The memory system according to claim 1, wherein the controller decreases the total quantity of credits based on determination that the read data is a speculative read miss.

10. A memory system comprising:
a memory sub-system; and
a controller configured to transmit a read command to the memory sub-system in response to a speculative read request received from a host device, or discard the speculative read request without transmitting the read command to the memory sub-system, according to a quantity of remaining credits.

11. The memory system according to claim 10, wherein the controller transmits the read command to the memory sub-system based on a determination that the quantity of remaining credits is greater than a reference value and decreases the quantity of remaining credits based on the transmission of the read command.

12. The memory system according to claim 10, wherein the controller discards the speculative read request without transmitting the read command to the memory sub-system, based on a determination that the quantity of remaining credits is a reference value.

13. The memory system according to claim 10, wherein the controller further adjusts the quantity of remaining credits based on receiving read data corresponding to the speculative read request from the memory sub-system.

14. The memory system according to claim 13, wherein the controller determines that the read data is a speculative read hit, based on receiving a normal read request corresponding to the speculative read request from the host device until a predetermined valid time from a time when the speculative read request is received.

15. The memory system according to claim 14, wherein the controller further adjusts a total quantity of credits and the quantity of remaining credits based on a determination that the read data is the speculative read hit.

16. An operating method of a memory system, the operating method comprising:
receiving a speculative read request from a host device;
transmitting, to a memory sub-system, a read command corresponding to the speculative read request according to a quantity of remaining credits and decreasing the quantity of remaining credits based on the transmission of the read command;
increasing the quantity of remaining credits based on receiving read data corresponding to the speculative read request from the memory sub-system; and
adjusting a total quantity of credits and the quantity of remaining credits according to whether the read data is a speculative read hit.

17. The operating method according to claim 16, further comprising discarding the speculative read request without transmitting the read command, based on a determination that the quantity of remaining credits is a reference value.

18. The operating method according to claim 16, wherein adjusting the total quantity of credits and the quantity of remaining credits includes increasing the total quantity of credits and the quantity of remaining credits based on a determination that the read data is the speculative read hit.

19. The operating method according to claim 16, wherein adjusting the total quantity of credits and the quantity of remaining credits includes decreasing the total quantity of credits based on a determination that the read data is a speculative read miss.

20. The operating method according to claim 16, further comprising determining whether the read data is the speculative read hit, based on receiving a normal read request corresponding to the speculative read request from the host device until a predetermined valid time from a time when the speculative read request is received.
